(19) United States
(12) Patent Application Publication
(10) Pub. No.: US 2023/0385362 A1
(43) Pub. Date: Nov. 30, 2023

(54) Minimum Click Media Search Engine

(71) Applicant: Jaclyn Prymicz, Chandler, AZ (US)

(72) Inventor: Jaclyn Prymicz, Chandler, AZ (US)

(21) Appl. No.: 17/752,744

(22) Filed: May 24, 2022

(51) Int. Cl. G06F 16/957; G06F 16/9538; G06F 3/0482

(52) U.S. Cl. CPC G06F 16/9574; G06F 16/9538; G06F 3/0482

(57) ABSTRACT

A search protocol usable on a cellular phone or on the internet is shown and described. The novel protocol minimizes a number of clicks or corresponding steps to locate, select, and retrieve audible and visible content such as a movie, a sporting event, a song, etc. available over a network. Diverse sources are sought by the query in a single click. A query responsively outputs a list of results including sources of the requested content of the query, availability of the content for each source, and costs for the sources. Optionally, the user can enter sources subscribed to, results of which are shown as free. The output may include links enabling direct access, an option to record content, and to purchase sought content. Content, links, or both may be stored in a hub for subsequent direct access. Changes in actual availability and in price may prompt notifications.

### FIELD OF THE INVENTION

The present invention relates to a computer media search engine for locating and presenting relevant data for desired distributed media content available to the public over a network. More particularly, the search engine presents selection making requiring a minimum of selection steps such as clicking on a link or icon.

### BACKGROUND OF THE INVENTION

People frequently watch informational and amusement presentations available on the internet or otherwise distributed over extensive data networks. Accordingly, there are many commercial and non-commercial sources of content any particular viewer may wish to view. The internet supports a number of search engines which a viewer may use locate and retrieve specific desired content for viewing.

While the current arrangement enables retrieval of many viewing options, it also entails an annoying drawback. Namely, should a user wish to view content at a later time, or view content more than once, or simply identify content and suitable sources of such content more than once, it becomes an annoying necessity to repeat many if not all of the steps performed in identifying, selecting, and retrieving content. There exists a need for search engine protocols which expedite retrieval after initial location and selection thereof by eliminating as many steps of locating and selecting the content as may be feasible.

### SUMMARY OF THE INVENTION

The present invention addresses the above need by providing search protocols which minimize the number of steps to located, select, and retrieve content. Content may include, by way of example, a movie, a television show, a sporting event, a concert, a song, a speech, a seminar, an article, an advertisement, or any other discrete work available over a network. The content may be audible, visible, or both. Diverse sources are sought by the query, and may include commercial entities such as Netflix, Amazon, Hulu, YouTube, On Demand, pay-per-view sources, and the like.

The novel search engine, executable at least on the internet or as an application carried on a personal mobile communications device, responds to a single query by producing a list of results. The list may show sources of the requested content of the query, actual availability of the content for each source, and the cost associated with each source.

Optionally, the user can enter sources subscribed to, so that content which may be ordered at no further cost to the user by virtue of subscription will appear in the resulting list of sources as being free.

The output list of results may also include links enabling the user to directly access the source to watch and listen to the contents, an option to record the sought content, or to transact a purchase of the sought content. Content, links, or both may be stored, e.g., in a hub for subsequent direct access.

Changes in actual availability and in price may optionally be the subject of notifications.

The present invention provides improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a depiction of prior art screen content of a prior art search engine;

FIG. 2 is a depiction of a representative opening screen of the novel search engine;

FIGS. 3-7 are depictions of exemplary screens encountered in sequential order after the opening screen of FIG. 2 has been invoked to initiate viewing of or listening to content;

FIG. 8 is a depiction of optional screen content encountered depending on a particular contingency; and

FIG. 9 is a depiction of optional screen content encountered depending on another particular contingency.

### DETAILED DESCRIPTION

The present invention is a method of operating a computer search engine for locating and presenting data relevant to desired media content available to the public over a network. The method takes a user from an initial step of initiating a selection process to making an actual selection, utilizing a minimal number of actuating steps, such as depressing a virtual key on a screen. The method may culminate in presentation of selected content for immediate viewing or listening or both, or alternatively, may place selected content in a state of readiness for future viewing or listening or both. Examples of future viewing or listening may involve purchasing the content, renting or leasing the content, scheduling the content for a specific future playing time, or monitoring availability of content from a service provider on the network.

The novel search engine is executable at least on the internet or alternatively as an application carried on a personal mobile communications device. Description herein is depicted using a personal mobile communications device such as a smart phone 100. The Drawings show content visible to a user on a screen 102 of smart phone 100. Commands are entered by contacting screen 102 by finger or stylus (neither shown), for example. The physical screen is designated herein by reference numeral 102. The use of other reference numbers associated with the term “screen” will be understood to refer to content displayed on physical screen 102. The same novel search engine may of course also be downloaded to and used on a personal computer, portable computer, and other data processing devices (none shown).

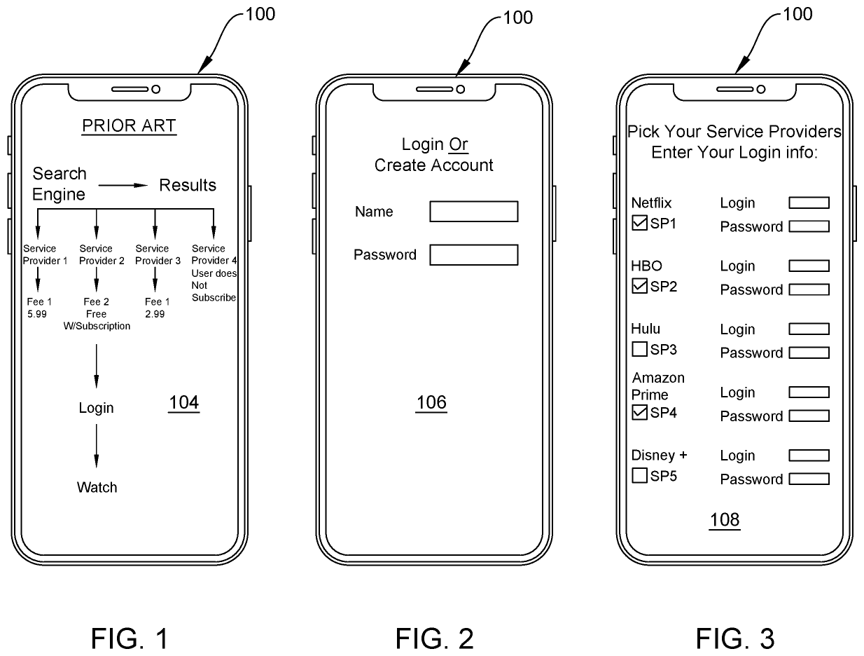

Referring first to FIG. 1, there is shown an exemplary screen 104 representative of the prior art. Screen 104 may be from a prior art search engine for example, and may be displayed on the same smart phone 100 to which the novel search engine may be downloaded. Nature and advantages of the novel search engine will be better understood and appreciated when description of the novel search engine is compared with this prior art screen and its associated method of operation. To this end, screen 104 and its use will be briefly reviewed.

Screen 104 presents a listing of selectable service providers SP-1, SP-2, SP-3, and SP-4. Respective fees for a single work or example of content (a movie, a play, a concert, etc.) are shown for each of the service providers. In the example of FIG. 1, the user has subscribed to or previously obtained access, e.g., by joining (i.e., becoming a member) service providers SP-1, SP-2, and SP3, but has not become eligible as a customer of service provider SP-4. The user considers the displayed choices available on screen 104, then selects one service provider SP-1, SP-2, or SP-3. The user is directed to an appropriate screen of the selected service provider SP-1, SP-2, or SP-3, and goes through a prescribed login procedure, affirms a choice of content, and then may watch or listen to the selected content. It is important to note that each of these steps must be repeated each time the user uses the prior art search engine.

The novel search engine both expedites the procedure, automatically placing manually entered data into memory so that separate or individual commands are combined into one, and also expands the number of available functions, each of which may be selected, again relying on combining steps into one, and bypassing redundant steps of data entry and selection.

In the novel search engine, and referring to FIG. 2, an opening screen 106 may start with a login procedure (or alternatively, for first time uses, creation of an account). An identifier (e.g., the user's name) and a private password are entered. With the identifier data block filled, upon entry of the password, a subsequent screen 108 is displayed (see FIG. 3).

In screen 108, the user is prompted to enter login and password data particular to each of a list of known service providers to which the user currently subscribes. In the example of FIG. 3, the user has manually selected (by contact with an appropriate area on screen 108) service providers SP-1, SP-2, and SP-4. These choices are confirmed by a cue such as a checkmark 110. Upon the user entering the requested login and password data and indicating selection of desired ones of the listed service providers, all of the entered login and password data is entered into memory. The user may for example contact an area designated as confirmatory (such as a legend “Enter”, not shown) to pass to a subsequent screen. In subsequent uses, it will merely be necessary that the user indicate which service provider is desired prior to confirming selection(s). Redundant future reentry of login and password data is eliminated.

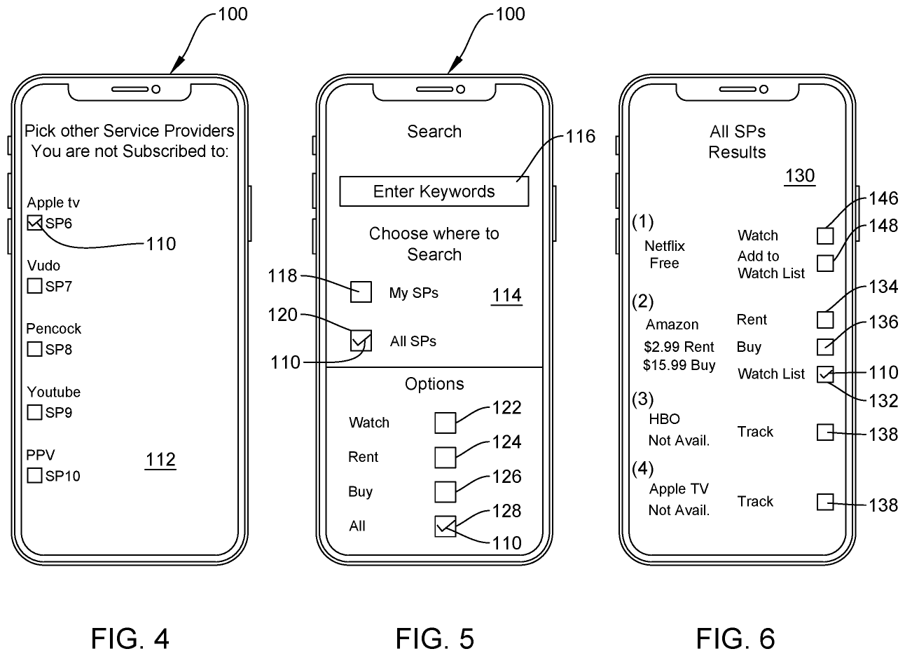

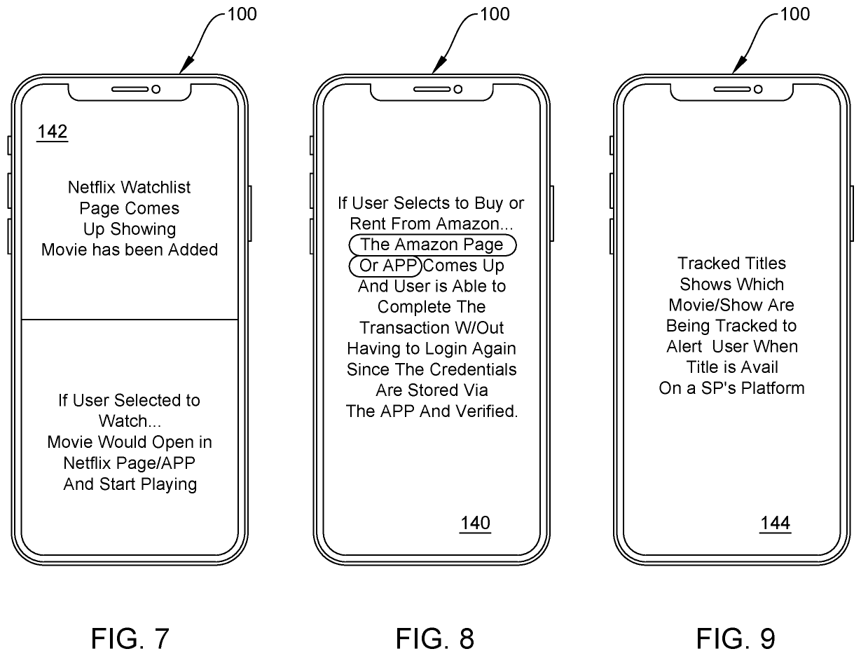

As soon as the user completes data entry (only during the first usage of the novel search engine), makes selections of listed service providers and confirms, a succeeding screen 112 may be displayed (see FIG. 4). In screen 112, a prompt requests the user to pick additional service providers not subscribed to (or a member of), where such unsubscribed service providers place content on the network accessible for viewing and listening. In the example of FIG. 4, the user has selected apple manually, eliciting check mark 110. Once again, completion of screen 112 may be confirmed, and a next screen 114 (FIG. 5) is displayed.

In the example of screen 114, the user is afforded an opportunity to select specific desired content by text searching of one or more key words (block 116). A further choice either limits the search to subscribed service providers (block 118) or alternatively, expands the search to additional service providers accessible on the network (block 120). Selection is confirmed by check mark 110.

In the example of screen 114, a final choice presented to the user is that of how he or she intends to utilize the selected content. Choices in this example include immediately watching the content (block 122, renting the content (block 124), purchasing the content (block 126), or a defined combination of these (block 128). This selection controls or enables future choices. In this example, the user has selected the combination (block 128). Again, the choice may be confirmed. Confirmation then summons a further screen 130 listing results of the search (FIG. 6) In this example, the user has elected to add content from a second listed service provider (“Amazon”) on the results listing to a watch list (block 132), indicated by checkmark 110. Designation of the watch list signifies that the selected content is entered into a queue maintained by the novel search engine, and that content will be presented in due course. The user will also choose whether to have the content streamed one time (rented, block 134) or purchased and downloaded (block 136). In this example, the user has elected to purchase the content. This is confirmed by check mark 110 in block 136. It should be noted that the search results listing shows costs and whether the content is not yet available. If currently unavailable content is desired, the user may select to track that content (blocks 138). Tracking causes the novel search engine to issue a notification that previously unavailable content has become available.

Optionally, search results may be prioritized to list user subscribed services first if the searched content is free by terms of the subscription.

After confirming the selections for screen 130, a screen 140 is presented. This screen is the opening screen for Amazon (as Amazon was selected in previous screen 130), or alternatively, a screen for an appropriate Amazon app. Note that it will not be necessary to reenter data manually in screen 140, as the novel search engine enters stored identification and password data. The user can then view or listen to the selected content.

Referring now to FIG. 8, a queue of selected content is displayed in a screen 142 for a particular service provider. The queue is automatically updated to include the latest selection(s). If the user has previously selected “watch”, then the content will start playing immediately. Once again, redundant entry of identification and password data is eliminated. The function described relative to screen 142 may occur chronologically before or after that of screen 140. Screen 142 may be initiated by a confirmation, cue, or prompt appearing on screen 140, for example.

FIG. 9 shows a screen 144 advising the user of tracked material, i.e., content which has been requested but is not yet available on the platform of the associated service provider. Screen 144 may be summoned by an affirmative command, or alternatively, may be pre-programmed by the novel search engine to be displayed at a particular time, such as upon conclusion of a played or finished presentation of content for example.

Thus far, there has been described an example of a user using one implementation of the novel search engine as the latter would be presented on smart phone 100. The invention may be defined as a method of operating a computer search engine for locating and presenting data relevant to desired media content available to the public over a network, the search engine at least partially residing on a host data processor and presenting selection options requiring a minimum of selection steps such as clicking on a link or icon. The method may comprise steps of performing a first affirmative command action of entering into the search engine a query identifying specific desired content, wherein the first affirmative command action may comprise entering a textual cue or an audible cue representing data identifying the desired content into a predetermined input location of the search engine, and subsequently entering a performance cue to execute a search for the desired content from diverse sourcing platforms connected to a network to which the search engine is connected.

Responsively to entering the first affirmative command action into the search engine, the method performs all steps necessary in the absence of any additional affirmative command actions to search all potential media sourcing platforms connected to the network and to identify and display on-screen a list of search results showing available sources of content relevant to the query. The method further comprises performing a second affirmative command action of indicating a selection from displayed available sources of content, wherein the second affirmative command action comprises entering a cue corresponding to the selection into the search engine. Responsively to entering the second affirmative command action into the search engine, the method includes performing all steps necessary in the absence of any additional affirmative command actions to present content according to the selection to the host data processor.

As employed herein, presenting data is generic to both storing and immediate consumption or display of content associated with presented data.

Performing a first affirmative command action of entering into the search engine a query identifying specific desired content is seen in the illustrated example in screen 114 (FIG. 5). It will be appreciated that prior screens and associated entered commands initiate operation of the novel search engine, but do not directly contribute to the process of selecting and performing (playing) of content. Once the search engine is enabled or initiated by commands, the actual selection-and-play process will include a text search (block 116, FIG. 5) of appropriate streaming or source platforms (blocks 118 and 120, FIG. 5). The novel search engine may be based on pre-qualifying or pre-selecting source platforms prior to entering the search query, then commanding play. Commanding play is seen in screen 130 (FIG. 6) as a choice including “watch” (block 146), “add to watch list” (block 148), “rent” (block 134), “buy” (block 136, or “track” (blocks 138).

The selections of selecting and actually playing or performing then can be performed by a first affirmative command (i.e., block 120 on screen 114 of FIG. 5) and a second affirmative command (i.e., block 146 of screen 130, FIG. 6). Supporting steps of initiating search engine operation and obtaining authorization of all potential streaming platforms have been previously performed, and can be activated as necessary with many individual steps eliminated, relying on storage to memory in the host device (e.g., smart phone 100). Illustratively, it is no longer required to redundantly enter personal identification and password for Amazon (the selected provider in FIG. 6).

Upon completion of the first and second affirmative commands, selections are made, and further prompts (i.e., succeeding screens) are presented without requiring additional affirmative commands.

In the method, identifying and displaying on-screen a list of search results may comprises generating a list of sourcing platforms and respective charges levied by each respective sourcing platform. Charges will include arranging payment of rental, purchase, or any use fee. Generating the list of sourcing platforms is seen in screens 108, 112, and 114 (blocks 18 and 120 in screen 114), respectively shown in FIGS. 3, 4 and 5.

In an option, the method may display the ordered list starting from a least cost sourcing platform option, and continues progressively by magnitude of costs to a maximal cost sourcing platform option. This is shown in Screen 130, FIG. 6.

The method may further include, prior to identifying and displaying the list of search results, a first option to limit the search to streaming services previously subscribed to, and a second option adding unsubscribed streaming services to the ordered list. This is seen in blocks 118 and 120 in screen 114 (FIG. 5). In addition, the user is able to select prior to the search, which streaming services it subscribes to and can either limit the search to those streaming services or can include other streaming services that it does not subscribe to. This is like a parameter based search.

The method may further comprise, when selecting subscribed streaming services, an option to pre-enter user credentials, so that upon presentation of choices of content, a next and sole command selectively invokes watching chosen content, downloading the chosen content, or save the chosen content to a pre-established queue for future watching. Pre-entry of user credentials is seen in screen 108 of FIG. 3. Watching, downloading, and saving are shown in blocks 122, 124, 126, or a combination of these, seen as block 128, in screen 114 (FIG. 5). For the selected services that the user has selected that it subscribes to, the user can pre-enter their credentials (user id and password) for that service prior to the search so that when the search result is presented, the user can direct click to the content, to watch, download, or save in a “watch later” queue. These options are shown in screen 130 of FIG. 6.

In the method, presenting content to the host data processor may comprise downloading data associated with the presented content into and storing downloaded data within the host data processor. This is implemented responsively to selection of options (blocks 122, 124, and 126 in screen 114 of FIG. 5, or as selection of blocks 134, 136, or 146 in screen 130 of FIG. 6.

In the method, presenting content to the host data processor may comprise downloading data associated with the presented content into and storing downloaded data within a hub associated with the host data processor.

In the method, presenting content to the host data processor may comprise streaming data associated with the presented content into the host data processor with immediate audible reproduction where streamed data corresponds to an audible output and for immediate visible reproduction where streamed data corresponds to a visible output. This is inherent in commands such as “watch” (block 122 in screen 114, FIG. 5, or block 146 in screen 130, FIG. 6). This recitation merely clarifies that streamed data may include audio content, video content, or both.

In the method, presenting content may comprise providing a link to the desired content. This option would be invoked automatically by the method where the content service provider has mandated use of a link. Again, in the novel method, selection of the content available via link automatically summons the link without requiring intermediate steps and commands. For example, in the method, providing the link may comprise displaying the link enabling the link to be immediately invoked by a person operating the search engine.

In the method, providing the link may comprise storing the link in a manner enabling subsequent display and invocation of the link by a person operating the search engine. Again, this is done entirely automatically by the novel search engine, with intermediate steps and commands eliminated.

In the method, providing the link may comprises storing the link in a hub associated with the host data processor.

In the method, identifying and displaying on-screen the ordered list of search results showing available sources of content relevant to the query and costs charged by each one of the available sources may include available sources previously made available to the person operating the search engine by an arrangement eliminating any discrete additional charge for consumption of content arising from ordering a selection of content from the available source offering the arrangement. That is, the novel search engine will identify when access has been prepaid by virtue of membership for example. This eliminates at least one step normally requiring an additional command. In one contemplated example, in the method, the available source offering the arrangement may operate as a subscription service. In a further example, the desired content incurs no additional charge if selected using the method for consumption, by virtue of terms of the arrangement. For example, in a movie streaming service, a tenth movie ordered in one month may be free, or the selection is within a free trial period.

In the method, the search engine may operate as a downloadable application for a personal communications device. Alternatively, the network associated with the search engine is the internet.

The method further comprise performing all steps necessary in the absence of any additional affirmative command actions to automatically generate a notification advising of any change in availability status of any listed selection. The notification may be transmitted to smart phone 100, to a PC used to host the novel search engine as internet based, or to another pre-determined communications device.

The method may further comprise performing all steps necessary in the absence of any additional affirmative command actions to automatically generate a notification advising of any change in pricing status of any listed selection.

The method may further comprise, prior to using the search function of the search engine, entering into memory credential data for each subscription based sourcing platform subscribed to by the person using the search engine, and thereafter, when using the search engine, limiting sourcing platforms to be searched to sourcing platforms subscribed to by the person operating the search engine, for which credential data has been priorly entered. In this example, after a one time initial entry of credential data, every search considers selectively for immediate consumption, future consumption, or future retrieval, subscription based sourcing platforms subscribed to by the person using the search engine without requiring more than one total affirmative command action. This is seen in Screen 108 of FIG. 3. Credential data refers to a user identification name and a password, for example. Future retrieval contemplates saving of a link, for example.

The method may further comprise, prior to using the search function of the search engine, entering into memory credential data for each subscription based sourcing platform subscribed to by the person using the search engine, and thereafter, when using the search engine, including among sourcing platforms to be searched subscription sourcing platforms subscribed to by the person operating the search engine as well as free sourcing platforms. After a one time initial entry of credential data, every search considers selectively for immediate consumption, future consumption, or future retrieval (e.g., via saved link), both free sourcing platforms and also subscription based sourcing platforms subscribed to by the person using the search engine without requiring more than one total affirmative command action.

The method may further comprise generating an ordered list of sourcing platforms and respective charges levied by each respective sourcing platform, wherein the ordered list starts from a least cost sourcing platform option including subscribed sourcing platforms from which the selection entails no further cost due to subscription terms, and continues progressively by magnitude of costs to a maximal cost sourcing platform option.

This is seen in screen 130 of FIG. 6, where rental and purchase of an Amazon product entails different costs.

Unless otherwise indicated, the terms “first”, “second”, etc., are used herein merely as labels, and are not intended to impose ordinal, positional, or hierarchical requirements on the items to which these terms refer. Moreover, reference to, e.g., a “second” item does not either require or preclude the existence of, e.g., a “first” or lower-numbered item, and/or, e.g., a “third” or higher-numbered item.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A method of operating a computer search engine for locating and presenting data relevant to desired media content available to the public over a network, the search engine at least partially residing on a host data processor and presenting selection options requiring a minimum of selection steps such as clicking on a link or icon, the method comprising steps of:
performing a first affirmative command action of entering into the search engine a query identifying specific desired content, wherein the first affirmative command action comprises entering a textual cue or an audible cue representing data identifying the desired content into a predetermined input location of the search engine and subsequently entering a performance cue to execute a search for the desired content from diverse sourcing platforms connected to a network to which the search engine is connected;
responsively to entering the first affirmative command action into the search engine, performing all steps necessary in the absence of any additional affirmative command actions to search all potential media sourcing platforms connected to the network and to identify and display on-screen a list of search results showing available sources of content relevant to the query;
performing a second affirmative command action of indicating a selection from displayed available sources of content, wherein the second affirmative command action comprises entering a cue corresponding to the selection into the search engine; and
responsively to entering the second affirmative command action into the search engine, performing all steps necessary in the absence of any additional affirmative command actions to present content according to the selection to the host data processor.

2. The method of claim 1, wherein identifying and displaying on-screen a list of search results comprises generating a list of sourcing platforms and respective charges levied by each respective sourcing platform.

3. The method of claim 2, wherein the ordered list starts from a least cost sourcing platform option, and continues progressively by magnitude of costs to a maximal cost sourcing platform option.

4. The method of claim 2, further including, prior to identifying and displaying the list of search results,
a first option to limit the search to streaming services previously subscribed to, and
a second option adding unsubscribed streaming services to the ordered list.

5. The method of claim 4, further comprising, when selecting subscribed streaming services, an option to pre-enter user credentials, so that upon presentation of choices of content, a next and sole command selectively invokes watching chosen content, downloading the chosen content, or saving the chosen content to a queue for future watching.

6. The method of claim 1, wherein presenting content to the host data processor comprises downloading data associated with the presented content into and storing downloaded data within the host data processor.

7. The method of claim 1, wherein presenting content to the host data processor comprises downloading data associated with the presented content into and storing downloaded data within a hub associated with the host data processor.

8. The method of claim 1, wherein presenting content to the host data processor comprises streaming data associated with the presented content into the host data processor with immediate audible reproduction where streamed data corresponds to an audible output and for immediate visible reproduction where streamed data corresponds to a visible output.

9. The method of claim 1, wherein presenting content comprises providing a link to the desired content.

10. The method of claim 9, wherein providing the link comprises displaying the link enabling the link to be immediately invoked by a person operating the search engine.

11. The method of claim 9, wherein providing the link comprises storing the link in a manner enabling subsequent display and invocation of the link by a person operating the search engine

12. The method of claim 11, wherein providing the link comprises storing the link in a hub associated with the host data processor.

13. The method of claim 1, wherein identifying and displaying on-screen the ordered list of search results showing available sources of content relevant to the query and costs charged by each one of the available sources includes available sources previously made available to the person operating the search engine by an arrangement eliminating any discrete additional charge for consumption of content arising from ordering a selection of content from the available source offering the arrangement.

14. The method of claim 13, wherein the desired content incurs no additional charge if selected using the method for consumption, by virtue of terms of the arrangement. (e.g., tenth movie ordered in one month is free, or the selection is within a free trial period)

15. The method of claim 1, wherein the search engine operates as a downloadable application for a personal communications device.

16. The method of claim 1, the method further comprising performing all steps necessary in the absence of any additional affirmative command actions to automatically generate a notification advising of any change in availability status of any listed selection.

17. The method of claim 1, the method further comprising performing all steps necessary in the absence of any additional affirmative command actions to automatically generate a notification advising of any change in pricing status of any listed selection.

18. The method of claim 1, further comprising
prior to using the search function of the search engine, entering into memory credential data (user ID and password) for each subscription based sourcing platform subscribed to by the person using the search engine, and
thereafter, when using the search engine, limiting sourcing platforms to be searched to sourcing platforms subscribed to by the person operating the search engine, for which credential data has been priorly entered, whereby after a one time initial entry of credential data, every search considers selectively for immediate consumption, future consumption, or future retrieval (a link is saved), subscription based sourcing platforms subscribed to by the person using the search engine without requiring more than one total affirmative command action.

19. The method of claim 1, further comprising prior to using the search function of the search engine, entering into memory credential data (user ID and password) for each subscription based sourcing platform subscribed to by the person using the search engine, and
thereafter, when using the search engine, including among sourcing platforms to be searched subscription sourcing platforms subscribed to by the person operating the search engine as well as free sourcing platforms, whereby after a one time initial entry of credential data, every search considers selectively for immediate consumption, future consumption, or future retrieval (a link is saved), both free sourcing platforms and also subscription based sourcing platforms subscribed to by the person using the search engine without requiring more than one total affirmative command action.

20. The method of claim 19, further comprising generating an ordered list of sourcing platforms and respective charges levied by each respective sourcing platform, wherein the ordered list starts from a least cost sourcing platform option including subscribed sourcing platforms from which the selection entails no further cost due to subscription terms, and continues progressively by magnitude of costs to a maximal cost sourcing platform option.
